(19) United States
(12) Patent Application Publication
(10) Pub. No.: US 2024/0086836 A1
(43) Pub. Date: Mar. 14, 2024

(54) ARTICLE MANAGEMENT METHOD, SERVER, AND PROGRAM

(71) Applicant: BANDAI CO., LTD., Tokyo (JP)

(72) Inventors: Hajime KONDO, Tokyo (JP); Hiroki KOBAYASHI, Tokyo (JP)

(21) Appl. No.: 18/263,413

(22) PCT Filed: Dec. 27, 2021
(86) PCT No.: PCT/JP2021/048675

§ 371 Date: Jul. 28, 2023

(30) Foreign Application Priority Data
Jan. 29, 2021 (JP) 2021-013029

(51) Int. Cl. G06Q 10/087

(52) U.S. Cl. CPC G06Q 10/087

(57) ABSTRACT

According to the present invention, article provision device information which relates to an article provision device satisfying a search condition of an administrator who administers an article provision device from which an article is provided and which includes stock information of the article to be provided from the article provision device is acquired; the article provision device information, in which the stock information in the article provision device information is shown as detailed information is presenting to an administrator terminal; the article provision device information which relates to the article provision device satisfying the search condition of the user and which includes the stock information of articles to be supplied from the article provision device is acquired, and the article provision device information in which the stock information of the article provision device is shown by the simple information different from the detailed information is presented to the user terminal.

### TECHNICAL FIELD

The present invention relates to an article managing method, a server and a program therefor.

### BACKGROUND

There is a technology for providing a different display, depending on a form of a terminal which displays information (Patent Document 1).

### PRIOR ART

### Patent Documents

[Patent Document 1] Japanese Patent Application Publication No. 2000-259640

### SUMMARY

### Technical Problem

However, in the Patent Document 1, the content of the display is not changed, so that the display may not meet purposes of a search performed by user. Therefore, it is an object of the present invention to provide a presentation, depending on a user who is at a different standpoint of the search purpose.

### Solution to Problem

One of the aspects of the present invention is an article management method. The article management method comprises a step of acquiring article provision device information which is information relating to an article provision device satisfying a search condition inputted by an administrator who manages the article provision device from which an article(s) is provided and includes stock information of articles to be provided from the article provision device; a step of presenting, to an administrator terminal, the article provision device information, in which the stock information in the article provision device information is shown as detailed information, a step of acquiring the article provision device information which is information relating to an article provision device satisfying a search condition inputted by a user and includes stock information of articles to be supplied from the article provision device, and a step of presenting, to a user terminal, the article provision device information in which the stock information in the article provision device is shown as simple information different from the detailed information.

Still another aspect of the present invention is a server. The server comprises a first acquisition unit for acquiring article provision device information which relates to an article provision device satisfying a search condition inputted by an administrator who manages the article provision device from which an article(s) is provided and which includes stock information of articles to be provided from the article provision device, a first presentation unit for presenting, to a user terminal, the article provision device information, in which the stock information in the acquired article provision device information is shown as detailed information, a second acquisition unit for acquiring the article provision device information which is information relating to the article provision device satisfying a search condition inputted by a user and includes the stock information of articles to be supplied from the article provision device, and a second presentation unit for presenting, to a user terminal, the article provision device information in which the stock information in the article provision device is shown as the simple information different from the detailed information.

Still another aspect of the present invention relates to a program. The program causes a computer to function as a first acquisition unit for acquiring article provision device information which relates to an article provision device satisfying a search condition inputted by an administrator who manages an article provision device from which an article(s) is provided, and which includes stock information of articles to be provided from the article provision device, a first presentation unit for presenting, to an administrator terminal, the article provision device information, in which the stock information in the article provision device information is shown as detailed information, a second acquisition unit for acquiring the article provision device information which relates to the article provision device satisfying the search condition of a user, and which includes stock information of articles to be supplied from the article provision device, and a second presentation unit for presenting, to a user terminal, the article provision device information in which the acquired stock information in the article provision device is shown as the simple information different from the detailed information.

### Advantageous Effect of Invention

According to the present invention, it is possible to present information which meets a search purpose inputted by a user.

### BRIEF DESCRIPTION OF DRAWINGS

FIG. 1 is a diagram showing an overall configuration of a management system according to an embodiment;

FIG. 2 is a block diagram showing an example of a provision device;

FIG. 3 is a block diagram showing an example of an administrator terminal;

FIG. 4 is a block diagram showing an example of a management server;

FIG. 5 illustrates an example of article provision device information;

FIG. 6 shows an example for explaining a display image;

FIG. 7 shows an example of administrator information;

FIG. 8 shows an example of a chart form;

FIG. 9 shows an example of a layout form;

FIG. 10 shows an example of a chart form;

FIG. 11 shows an example of an object form;

FIG. 12 is a sequence diagram for explanation of an operation;

FIG. 13 is a flowchart of update processing;

FIG. 14 is a flowchart of first presentation processing;

FIG. 15 shows an example of a table form;

FIG. 16 is a flowchart of second presentation processing;

FIG. 17 shows an example of a search screen;

FIG. 18 shows an example of sales information;

FIG. 19 shows an example of a heat map form;

FIG. 20 shows an example of a heat map form;

FIG. 21 shows an example shown in a graph;

FIG. 22 shows an example of settlement information;

FIG. 23 shows an example of article provision information according to a third embodiment; and

FIG. 24 shows an example of a chart form.

### DETAILED DESCRIPTION

### First Embodiment

[Overview of System]

A first embodiments of the present invention will be described below.

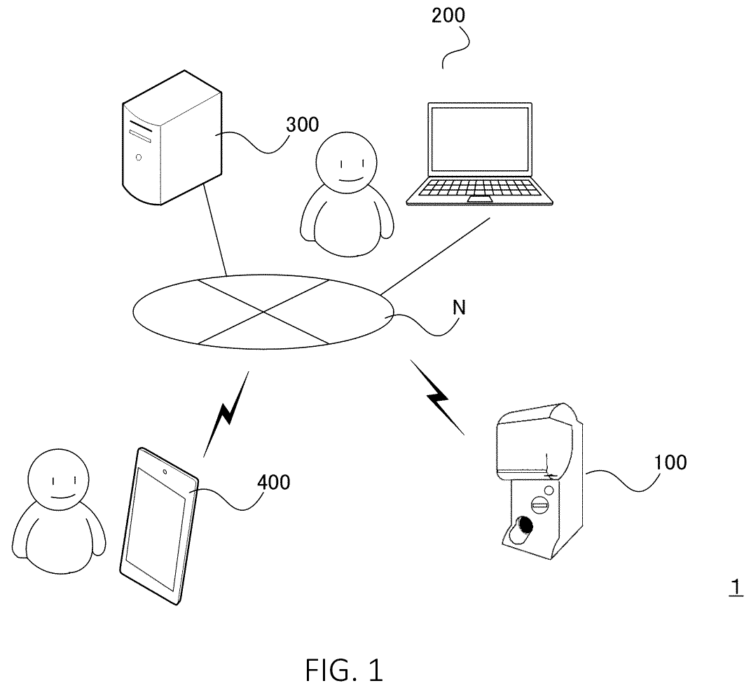

FIG. 1 is an overall configuration of a management system according to the present invention. The management system 1 comprises a provision device 100, an administrator terminal 200, a management server 300, and a user terminal 400. The provision device 100 and the administrator terminal 300 can communicate with each other via a communication line N. Similarly, the administrator terminal 200 and the management server 300 can communicate with each other via the communication line N. The user terminal 400 and the management server 300 can communicate with each other via the communication line N. The communication line N means a communication path capable of data communication. That is, the communication line N includes a communication network, such as a telephone communication network, a cable network, the internet, etc., in addition to a LAN established by a dedicated line(s) (dedicated cable) for direct connection or an Ethernet (registered trademark) and the like. The communication can be performed by any method, and may be either wired or wireless.

<Provision Device 100>

The provision device 100 is a device for discharging and selling (providing) an article(s), which is represented by a capsule toy, trading cards and the like. The capsule toy is included as an article in a spherical capsule. Recently, there is an article in form of a sphere, wherein the discharged article itself can be put together. In the present invention, the shape of the article and that of the capsule to be provided do not matter, and they may be any shape.

The provision device 100 is set in a sales area and is managed by an administrator which will be described later. For example, the sales area is a shopping mall, a station premise, a store and the like. The number of provision devices 100 is not limited to one, may be two or more. At least one provision device 100 is installed in the sales area. A provision device ID is assigned to each of the provision devices 100 for uniquely identifying the provision unit.

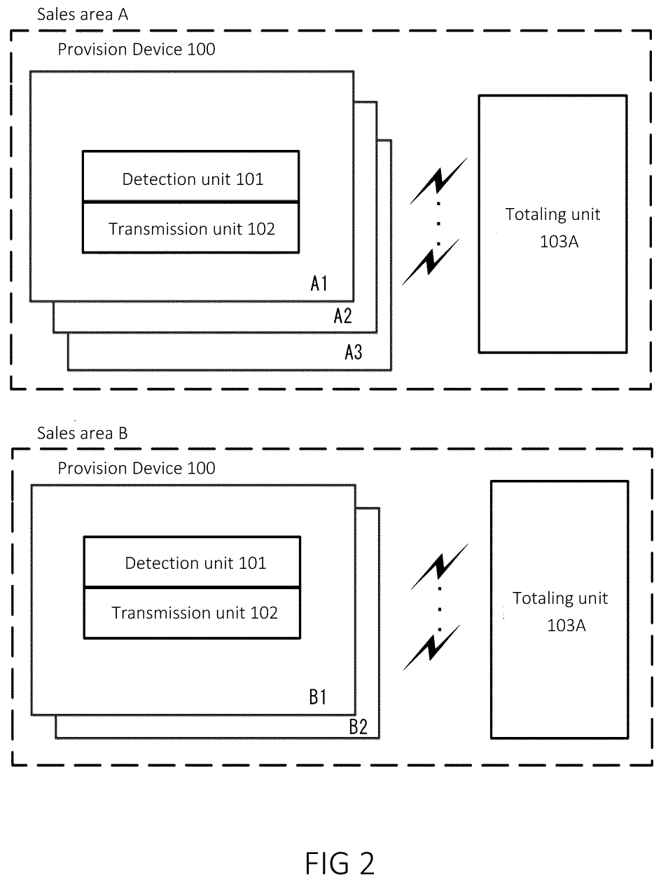

FIG. 2 shows a configuration example in case where three provision devices 100 (A1-A3) are installed at a sales area A by an administrator X, and two provision devices 100 (B1-B2) are installed at a sales area B by an administrator Y. Each of the provision devices 100 is equipped with a detection unit 101 for detecting discharge of an article, and a transmission unit 102.

When the provision device 100 provides an article, the detection unit 101 detects it, and generates provision information. The provision information includes a provision device ID and the number of provisions (the number of sales) and date of transmission of the provision information. The number of provision is the number of articles provided by the provision devices 100. As the method of detecting an article by the detection unit 101, a method of detecting a user's operation performed to an operation unit at time when an article is provided, or a method of detecting an article which passes through a provision outlet for providing the article, by an infrared light sensor etc. is considered. Either of the methods may be adopted or another method may be adopted. The detection unit 101 generates the provision information when a predetermined transmission conditions are satisfied and transmits it through the transmission unit 102. The predetermined conditions are satisfied when the detection unit 101 detects provision of an article, when the number of counts of article provision detected by the detection unit 101 reaches a predetermined number, or when a pre-set time elapses, and/or when a transmission request for the provision information is received from a totaling unit 103 which will be described later. These conditions may be combined or other condition(s) may be adopted. The transmission unit 102 transmits the provision information generated by the detection unit 101 to the totaling unit 103.

A totaling unit 103 is installed at each sales area. The totaling unit 103 receives the provision information transmitted from the transmission unit 102 of each provision unit 100 and transmits it to the management server 300 when a predetermined condition(s) are satisfied. The predetermined condition(s) is satisfied when the provision information is received from the provision device 100, when the predetermined number of pieces of the provision information is received from the provision device 100, when a pre-set time elapses, and/or a transmission request for provision information from the management server 300 etc. is received. These conditions may be combined or other condition(s) may be adopted.

<Administrator Terminal 200>

The administrator terminal 200 is a terminal operated by an administrator of the provision device 100. Here, explanation about the administrator will be given below. The administrator is an operator who installs a provision device(s) 100 at a sales area, manages the provision device(s), or manages sales of articles provided by the provision device(s) 100. The administrator may be a manufacturer or a sales agent (vender) etc. The manufacturer is an enterprise which manufactures articles. The sales agent who lays in a stock of articles manufactured by the manufacturer and sells them.

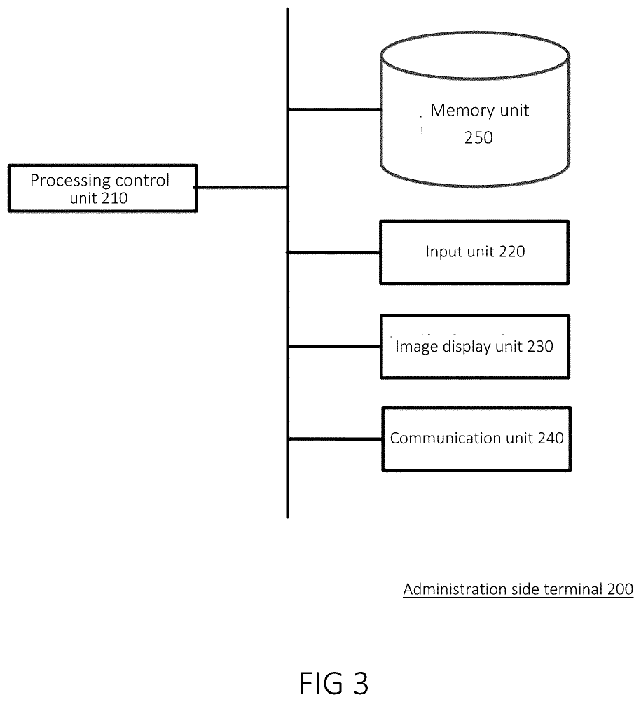

The administrator terminal 200 is, for example, a smart phone, a cell phone, a personal computer, a tablet type terminal or the like. The administrator terminal 200 displays information presented by the management server 300 on a screen thereof by using a web browser etc. Basically, there are two or more administrator terminals 200. In explanation set forth below, a configuration in case where the administrator terminal 200 is a personal computer will be described. As show in FIG. 3, the administrator terminal 200 includes a processing control unit 210, an input unit 220, an image display unit 230, a communication unit 240 and a memory unit 250.

The processing control unit 210 totally controls an operation of the administrator terminal 200 based on a program, data stored in the memory unit 250 and an operation input signal etc. from the operation input unit 220. The function of the processing control unit 210 can be realized by, for example, a microprocessor such as a CPU, a GPU, etc., and electronic components such as an ASIC and an IC memory etc.

The processing control unit 210 coverts HTML etc. acquired from the management server 300, into interactive documents by a layout engine of the web browser, and display it. When plug-ins corresponding to a flash application or Java applet are prepared, they can be displayed or performed. In addition, the processing control unit 210 performs data processing and communication connection for data communication with the management server 300 etc. through the communication unit 240.

The input unit 220 is provided to inputs various kinds of operations performed by the user, and outputs an operation input signal to the processing control unit 210 according to the operation input. The input unit 220 can be realized by, for example, a keyboard, a mouse, a touch panel etc. in case of a personal computer. In case of a tablet terminal, a smart phone, a cell phone, it can be realized by an element directly manipulated by a finger of the user, such as a touch operation pad, a home button, a button switch, a joystick, a trackball, etc., or by an element, which detects a motion or posture, such as an acceleration sensor, an angular velocity sensor, an inclination sensor, and a geomagnetic sensor, etc.

The image display unit 230 displays a screen based on an image signal inputted from the processing control unit 210. The image display unit 230 is, for example, a display device, such as a flat panel display, a cathode ray tube (CRT), a projector, a head-mounted display, etc.

The communication unit 240 achieves communication by connecting with the communication line N. Functions of the communication unit 240 can be realized by, for example, a wireless communication device, a modem, a TA (terminal adapter), a jack of a communication cable and a control circuit for wired communication, and the like.

In the memory unit 250, programs for causing the administrator terminal 200 to work therewith and for realizing various functions provided in the administrator terminal 200, and data etc. used during running of the programs are stored in advance, or such programs and data are temporarily stored every time each processing is performed. The memory unit 250 can be realized by, for example, an IC memory, such as a RAM, a ROM, a flash memory, etc., a magnetic disk such as a hard disk, etc., or an optical disc, such as a CD-ROM, a DVD, etc. Specifically, in the memory unit 250, a system program and a control program for performing processing of the browser etc. are stored. The system program realizes a basic function of the terminal 2 as a computer. The control program causes the processing control unit 210 as a browser control unit.

<Management server 300>

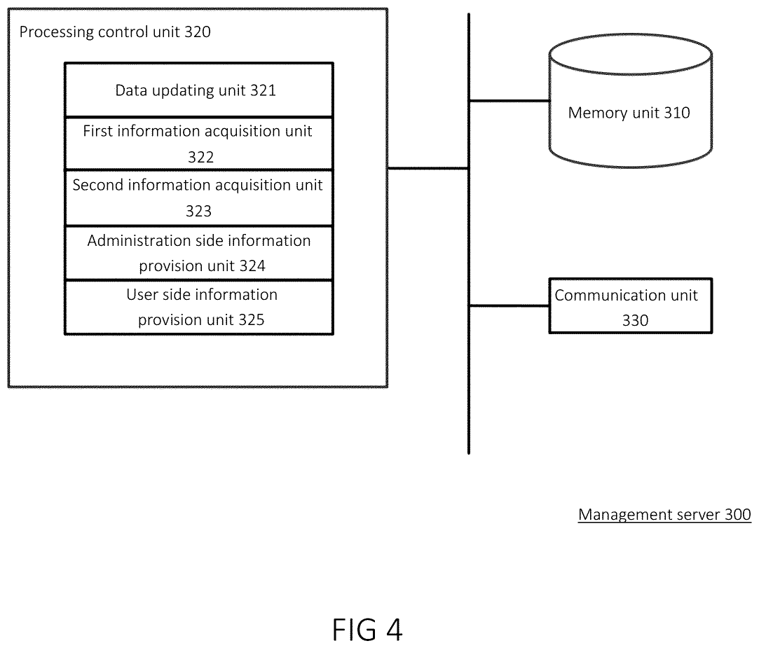

The management server 300 is prepared by an administrator who manages the article provision devices 100. The management server 300 is provided on a network, and includes a virtual server, configured by a cloud type platform. As shown in FIG. 4, the management server 300 includes a memory unit 310, a processing control unit 320 and a communication unit 330.

In the memory unit 310, a system program for realizing the basic function of the management server 300 as a computer is stored. Further, in the memory unit 310, the article provision device database, administrator information and data for screen formats is stored.

In the article provision device database, article provision device information is stored. The article provision device information includes article information and provision device information.

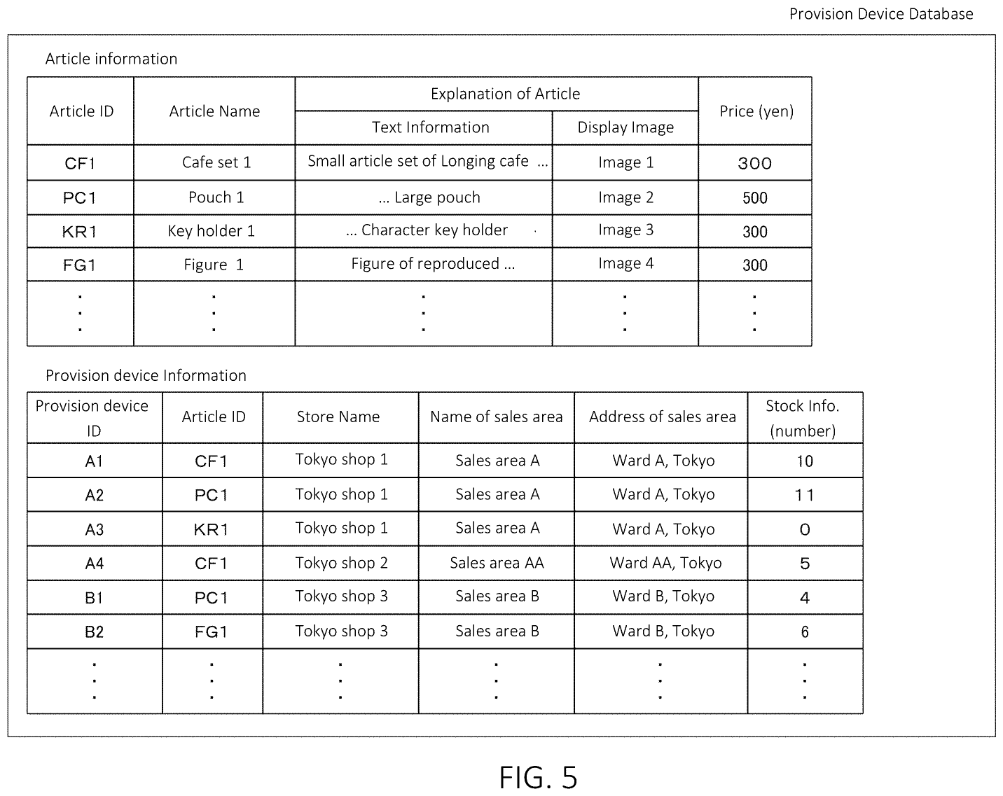

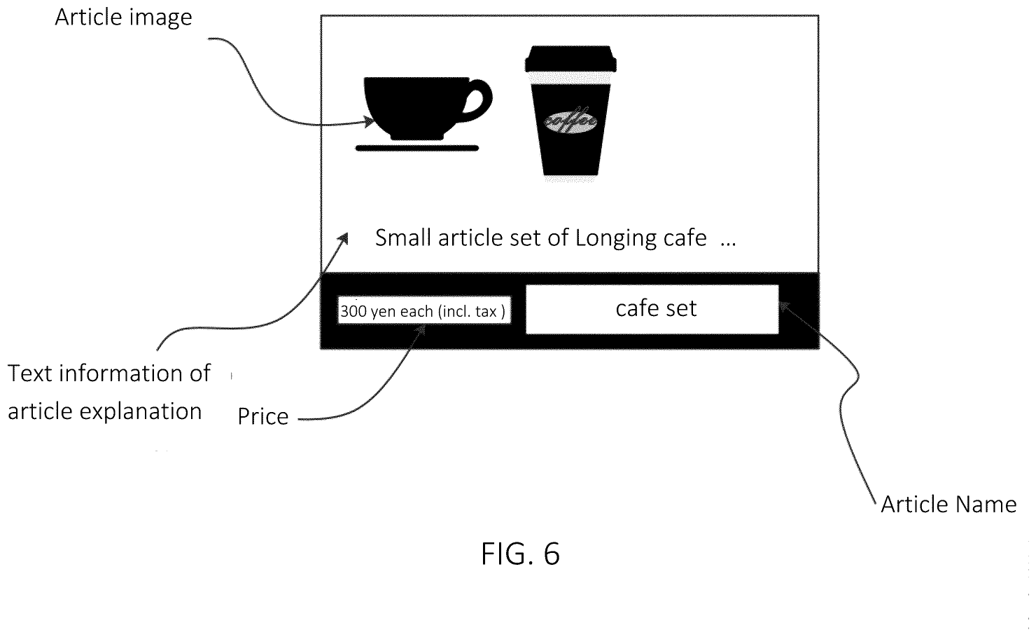

As shown in FIG. 5, one record of the article information, comprises an article ID, an article name, explanation of the article, a price thereof, which are associated with one another. The article ID is identification information for uniquely identifying an article supplied from a provision device 100. The article name is a name of the article. The explanation of the article includes at least one of text information and a display image. The text information includes an article explanation such as a characteristic of the article, an assembling method, an explanation as to how to play, and the like. The display image is an image displayed on or actually attached to the provision device 100. As shown in FIG. 6, the display image includes information of at least one of the article name, a price thereof, an introductory sentence of the article, an image of the article. Regarding the article name, the price, and the introductory sentence may be the same as the article name of the article information, and the price may be the same content as that of the information written in the text information of the article explanation. The images of the articles are, for example, images of all kinds of articles which are randomly provided by a provision device 100. The images of the articles include images thereof before and after the assembly in the case of an assembly type article. The price is the sales price of the articles.

As shown in FIG. 5, one record of the provision device information comprises a provision device ID, an article ID, a store name, the name of a sales area, the address of the sales area, and stock information, which are associated with one another. The provision device ID is identification information for uniquely identifying a provision device 100, and is, for example, attached to or engraved on the provision device 100. The article ID is identification information for uniquely identifying an article provided by the provision device 100 and is similar to the above-described article ID of the article information. The store name is a name of the store where the provision devices 100 are installed. The name of the sales area is a name of a facility where stores are operated, for example, a name of shopping mall. The address of the sales area is an address of a place where the provision devices 100 are installed. The stock information is the number of articles in stock in the provision device 100. In addition, the store name, the name of the sales area and the address of the sales area are collectively called as sales area information.

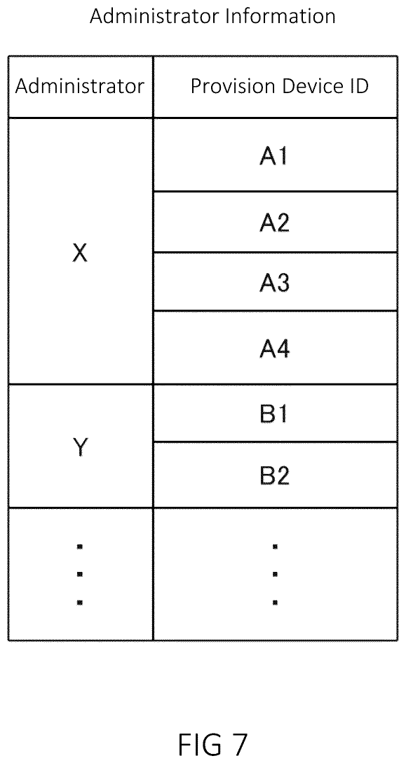

As shown in FIG. 7, in the administrator information, the provision device ID of the provision device 100, which is managed by an administrator, is stored so as to be associated with the administrator ID. The administrator ID is identification information for uniquely identifying an administrator. The provision device ID is identification information for uniquely identifying a provision device 100, and is similar to the provision device ID of the above-described provision device information.

The data for screen formats includes formats in which display forms to be displayed on display screen of the administrator terminal 200 and the user terminal 400 are defined. For example, screen formats for a login screen, a menu screen, a search screen, and information presentation screen and the like are prepared as such display screens of the administrator terminal 200. Screen formats for a menu screen, a search screen, information provision screen and the like are prepared as such display screens of the user terminal 400.

The processing control unit 320 totally controls operations of the management server 300 based on programs stored in the memory unit 310. The processing control unit 320 includes a data updating unit 321, a first information acquisition unit 322, a second information acquisition unit 323, an administration information provision unit 324 and a user side information presentation unit 325.

The data updating unit 321 searches the provision device information for a provision device ID which is the same as a provision device ID included in provision information transmitted from the totaling unit 103, and the number in stack information associated with the searched provision device ID is reduced by the number of provision included in the provision device information. In addition, the data updating unit 321 increases the stock quantity by the number of replenished articles when the provision unit 100 is replenished with the articles by an administrator.

The first information acquisition unit 322 acquires, from the article provision device database, article provision device information which is matched on the search condition inputted (designated) by the administrator, using the administrator terminal 200. Here, a search target range of the first information acquisition unit 322 is the provision device information of the provision device 100 which is managed by the administrator. In view of data breach, it is configured that information of a provision device 100 which is administered by another administrator may not be presented. That is, it is also paraphrased as the provision device information of the provision device 100 for which browsing authority is required, since only the administrator who has right to browse can read the provision device information of the provision device 100, which is the search target range of the first information acquisition unit 322.

The first information acquisition unit 322 acquires the article provision device information including the inputted search condition, from the article provision device database. When two or more search conditions are inputted, it acquires article provision device information which meets all the search conditions, from the article provision device database. When the administrator wants to know the stock information of the provision device 100 installed in a sales area, he or she inputs any one of a store name, a name of the sales area, and an address of the sales area information, as a search condition. In this case, the first information acquisition unit 322 acquires the provision device information of a record(s), which includes any one of the store name, the name of the sales area, and the address of the sales area information. In addition, when he or she wants to know stock information of a specific article, an article name such as “pouch”, “keyholder”, or “a character name” is inputted as the search condition. The first information acquisition unit 322 acquires the article information of a record(s) including the search condition from the article provision device database, and acquires the provision device information of a record(s) including the article ID which is the same as the article ID of the article information of the acquired record.

The second information acquisition unit 323 acquires, from the article provision device data base, article provision device information which is matched on the search condition inputted (designated) by a user, using the user terminal 400. Here, the second information acquisition unit 323 acquires the provision device information of the provision device 100 for which browsing authority is not required. The article provision device of the provision device 100 for which browsing authority is not required means a user can gain access to the information with or without the right to read, that is, it is provision device information which can be read by all users. In addition, the article provision device information of the provision device 100 for which browsing authority is not required means the provision device, for which a provision device ID exists in the provision device information. Since an article will be able to sold to a user if articles are replenished in a provision device 100 in which the stock is zero, the provision device ID of the provision device 100 remains in the provision device information without being removed. On the other hand, since no article can be provided to a user when a provision device 100 is removed from the sales area or has a breakdown, such a provision device ID of that provision device 100 is deleted from the provision device information. Therefore, in the present embodiment, a provision device which can sell an article to a user means a provision device for which the provision device ID exists in the provision device information.

The second information acquisition unit 323 acquires article provision device information of a record(s) including the inputted search condition. When two or more search conditions are inputted, it acquires article provision device information of a record which satisfies all the search conditions. When the user wants to know what articles are provided at a sales area he or she plans to visit, he or she inputs part of any of the store name at the sales area, a name of the sales area, and an address thereof in the sales area information, as a search condition. In this case, the second information acquisition unit 323 acquires the provision device information of a record(s) which includes any one of the store name at the sales area, the name of the sales area, and the address thereof, and acquires, from the article information, article information of a record (9) including an article ID which is the same as the article ID in the provision apparatus information of the acquired record(s). In addition, when he or she wants to know sales areas for a desired article, at least part of a name of the desired article, such as “pouch”, “keyholder”, or “a character name” is inputted as a search condition. The second information acquisition unit 323 acquires article information of a record(s) including the search condition from the article provision device database, and acquires the provision device information of a record including the article ID which is the same as the article ID of the article information of the acquired record. Regarding the article provision device information which is acquired by the second information acquisition unit 323, all the items in the record(s) which meets the search condition may be acquired. However, only information of items which needs to be presented to the user may be acquired from among the items in the record which satisfies the search condition. In addition, the acquired provision device information includes at least stock information.

The administration side information presentation unit 324 presents, to the administrator terminal 200, a log-in screen, a menu screen, a search screen, or information presentation screen according to a screen format. The administration side information presentation unit 324 presents the article provision device information acquired by the first information acquisition unit 322, to the administrator terminal 200, according to the screen format for information presentation. The article provision device information presented by the administration side information presentation unit 324 is information in which predetermined items among pieces of the article provision device information acquired by the first information acquisition unit 322 are written, the predetermined items includes the stock information. Here, the stock information is presented as information in detail (hereinafter referred to as detailed information) for the administrator. This is because the article provision device information is presented to the administrator side, and the administrator needs the detailed information for managing stock quantity. Here, the detailed information may need to be, for example, the current stock quantity or daily stock quantity shown by a specific numerical value, or accurate information which deems to be necessary for the administration.

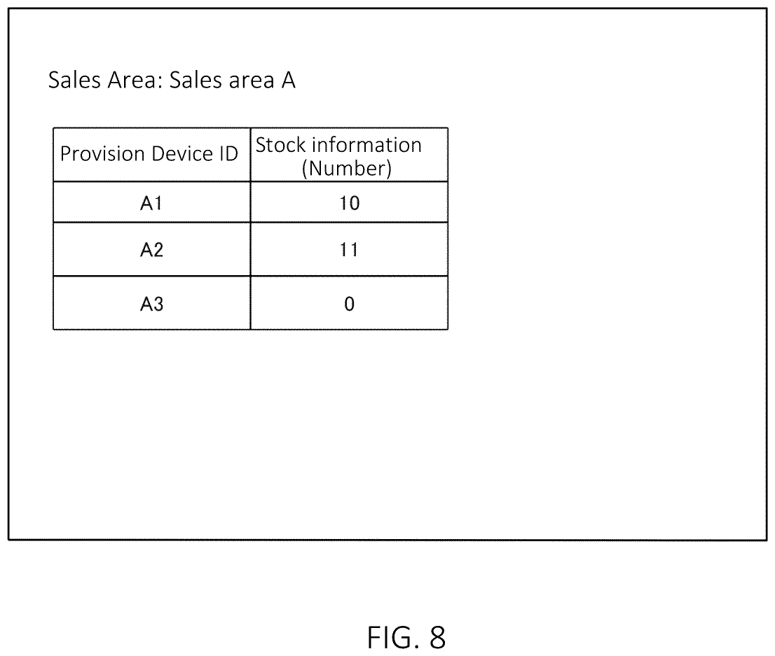

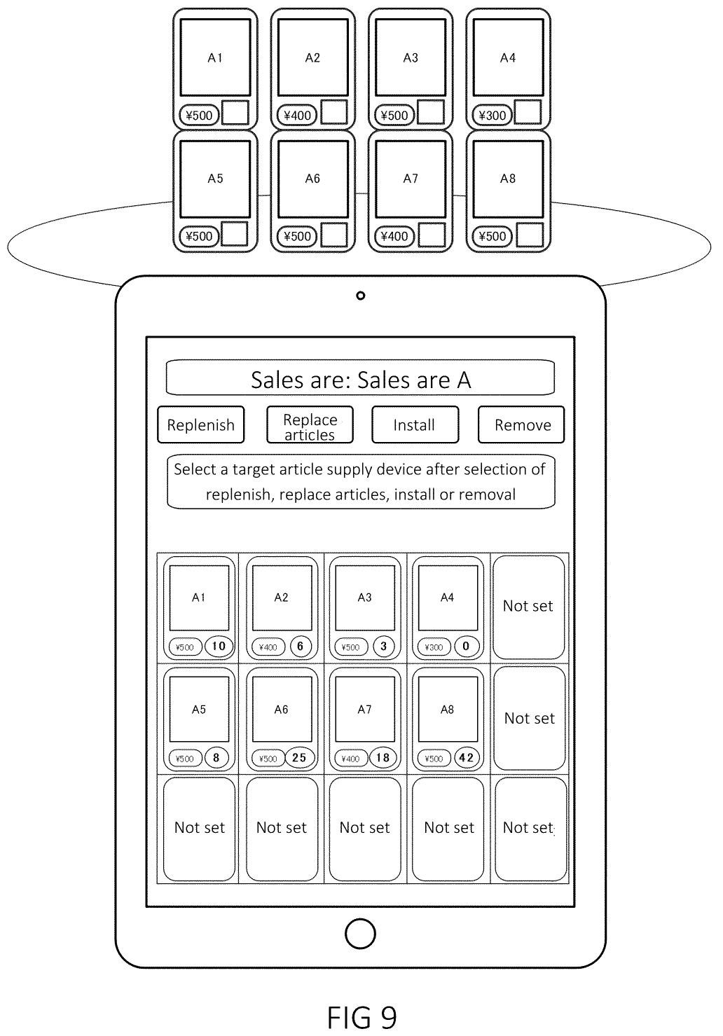

Further, the presentation format of the article provision device information to be presented to the administrator can be selected between two types of formats. In the first format, the article provision device information is presented in form of a chart. In the chart format, items required for the article provision device information are displayed in form of a chart, a table, and/or a graph. For example, when the administrator inputs “sales area A”, which is information of the sales area, as the search condition, in order to show the stock information, as shown in FIG. 8, a table in which a provision device ID and stock information is included in each record, is associated with the sales area information “Sales area A”, and is displayed. In the second format, the article provision device information is presented in form of a layout. In the layout form, pieces of information required for the article provision device information of each of the provision devices 100 are arranged, so as to correspond to arrangement/layout of the provision devices 100 installed in the sales area. When the administrator inputs “Sales area A” as the sales area information for a search condition so that stock information is presented, as shown in FIG. 9, the stock information is superimposed on an object image of each provision device 100, corresponding to arrangement/layout of the provision devices 100 installed in the sales area, and is associated with “Sales area A” which is the sales area information, thereby being displayed. In addition, the stock information may be arranged near the object image.

The user side information presentation unit 325 presents a menu screen, a search screen, and/or an information presentation screen according to the respective screen formats to the user terminal 400. The user side information presentation unit 325 presents the article provision device information which is acquired by the second information acquisition unit 323 according to the screen format of the information presentation screen. Here, the user side information presentation unit 325 converts and presents the stock information into simple information, which is different from the above-described detailed information to be presented to the administrator, wherein the simple information is less detailed than the detailed information. The simple information may be any type as long as the simple information is less detailed than the detailed information, and may be, for example, a stock level which is set according to the stock quantity in the stock information. “In-stock” is displayed in case where the stock quantity is 11 or greater, “Low stock (limited stock)” is displayed in case where the stock quantity is 1 to 10, and “No stock” is shown in case where there is not any stock. In addition, the stock level may be displayed by a symbol, such as a circle (in-stock), a triangle (low stock) and X (not in stock), or in-stock, low stock, not-in-stock may be displayed by using intuitively recognizable object image. However, as described above, the stock information to be presented needs to be less detailed than the detailed information to be presented to the administrator.

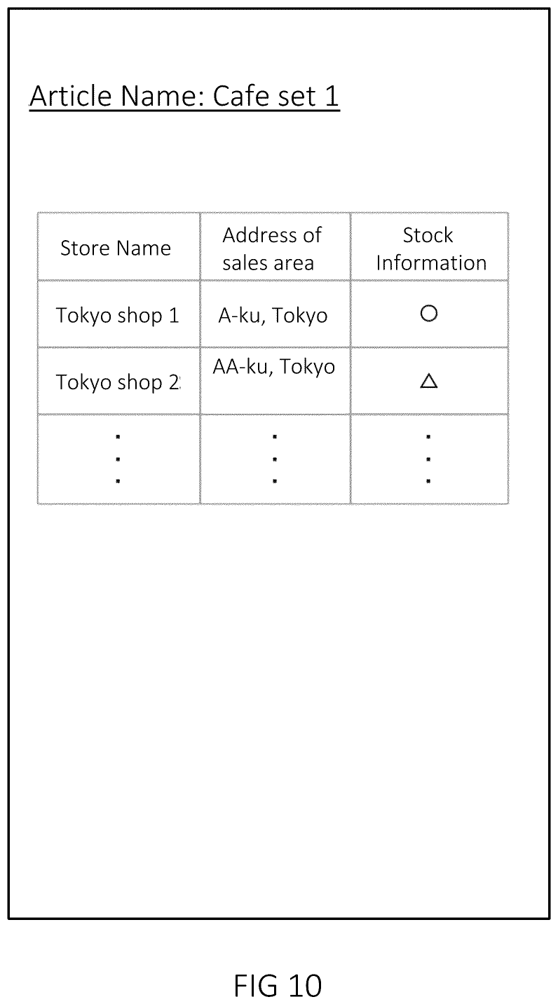

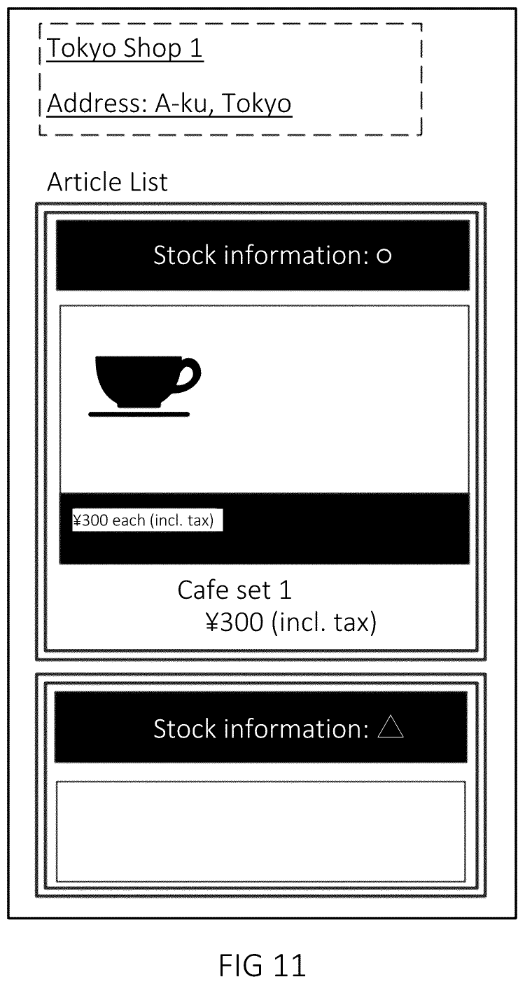

There are two types of presentation formats of the article provision device information in the information presentation screen presented to a user side. In the first format, the article provision device information is presented in form of a chart. In the chart format, items required for the article provision device information are displayed in form of a chart, a table, and/or a graph. For example, when a sales area(s) where a certain article is provided is displayed by inputting “café set”, which is information of the article, as the search condition, as shown in FIG. 10, a table in which a store name, a sales area address and stock level information is included as one record, is associated with “a café set 1” which is the article information, and is presented. In the second format, the article provision device information is presented in form of an object. In the object form, a display image of each provision device installed in the sales area and stock level information is displayed as one object image. For example, when a user inputs “Tokyo shop 1”, which is store information, as a search condition, as shown in FIG. 11, the object, in which a display image is arranged below a symbol “o”, indicating the stock level information, is associated with the store information, and is displayed. In addition, one object image may include the price information of the article.

<User Terminal 400>

The user terminal 400 is a terminal operated by a user. The user means a purchaser who desires a provision of an article from a provision device 100. Since the user does not have a browsing authority, he or she may not read the provision device information of the provision device 100 which requires the right to read. The user terminal 400 is, for example, a smart phone, a cellphone, a personal computer, a tablet terminal and the like. Basically, there are two or more user terminals 400. In explanation set forth below, a configuration in case where the user terminal 200 is a smart phone will be described.

The user terminal 400 is equipped with a processing control unit 410, an input unit 420, an image display unit 430, a communication unit 440, and a memory unit 450. The configuration of each of the processing control unit 410, the input unit 420, the image display unit 430 communication unit 440, and the memory unit 450, is similar to that of the control unit 210, the input unit 220, the image display unit 230, the communication unit 240, and the memory unit 250 in the administrator terminal 200. Therefore, detailed explanation thereof is omitted.

<Operation>

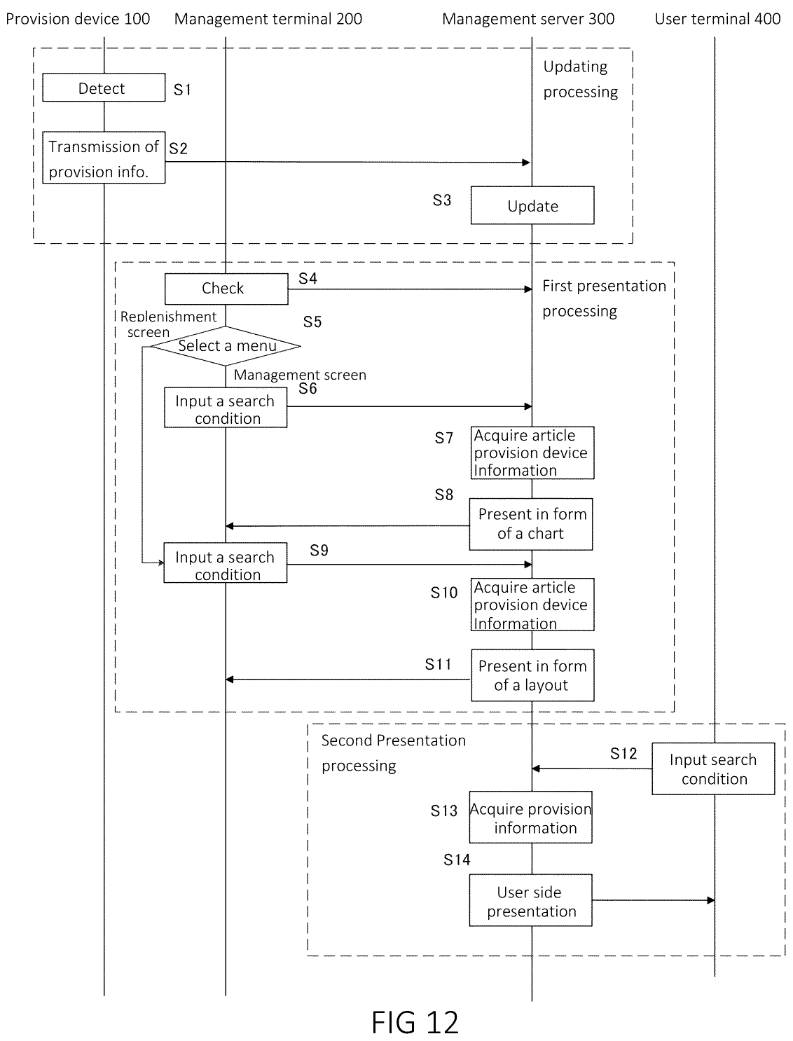

FIG. 12 is a sequence diagram of an operation in the management system according to the present embodiment. The operation of the management system 1 will be explained, referring to FIG. 2. In addition, in order to simplify description thereof, explained below is an example, in which the detection unit 101 generates and transmits provision information every time a provision of one article is detected, and the totaling unit 103 transmits the provision information to the management server 300 every time the totaling unit 103 receives the provision information from the provision device 100.

<Updating Processing>

The detection unit 101 generates the provision information when detecting a provision of an article in the provision device 100 (Step 1). The transmission unit 102 transmits the provision information generated by the detection unit 101, to the management server 300 through the totaling unit 103 (Step S2). The data updating unit 321 updates stock information of the provision information when it receives the provision information (Step S3).

<First Provision Processing>

The administrator performs authentication by inputting the administrator ID and password on a login screen displayed on the administrator terminal 200 (Step S4). The administrator makes a selection for either a management screen or a replenishment screen on a menu screen displayed on the administrator terminal 200 (Step S5). When the management screen is selected, the administrator inputs a search condition on a search screen displayed on the administrator terminal 200 (Step S6). The first information acquisition unit 322 acquires provision device information of the provision device 100 which satisfies the inputted search condition (Step S7). The administrator side information presentation unit 324 presents the article provision device information acquired by the first information acquisition unit 322, to the administration terminal 200 (Step S8). At this time, the article provision device information is presented in the form of chart, and the stock information is presented as stock quantity. When the replenishment screen is selected, the administrator inputs information regarding a sales area in the search screen displayed on the administrator terminal 200 (Step S9). The first information acquisition unit 322 acquires the provision device information of the provision device 100 which satisfies the inputted search condition (Step S10). The administrator side information presentation unit 324 presents the provision device information acquired by the second information acquisition unit 323, to the administrator terminal 200 (Step S11). In the layout format, the article provision device information is presented and the stock information is presented as stock quantity.

<Second Presentation Processing>

The user inputs a search condition on the search screen displayed on the user terminal 400 (Step S12). The second information acquisition unit 323 of the management server 300 acquires provision information of the provision device 100 which satisfies the search condition (Step S13). The user side information presentation unit 325 presents the article provision device information acquired by the second information acquisition unit 323, to the user terminal 400 (Step S14). At this time the stock information of the provision device information is presented as a stock level.

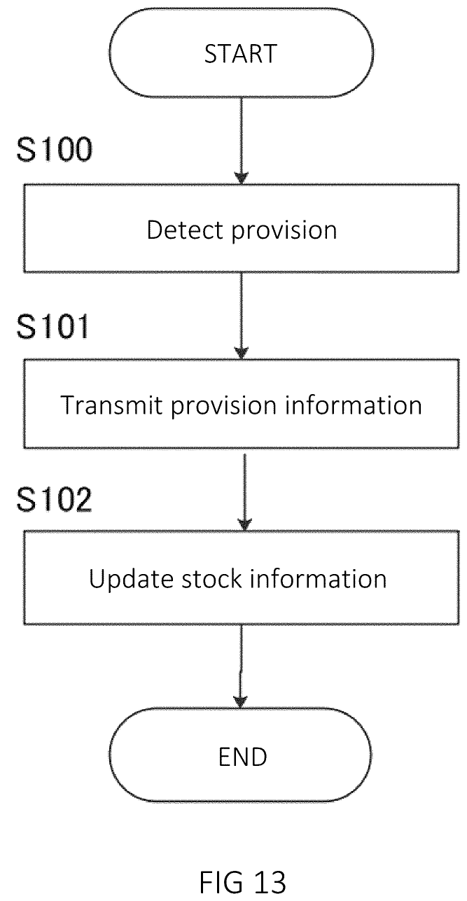

Next, each processing will be described in detail. First, updating processing will be described referring to a flowchart of FIG. 13. As shown in FIG. 3, described below is a configuration example of the provision devices 100, in which the provision devices 100 (A1-A3) and the totaling unit 103A are installed at the sales area A and the provision devices 100 (B1-B2) and the totaling unit 103B are installed at a sales area B. In addition, in the explanation of the example set forth below, the article provision devices 100 transmits provision information every time provision of one article is detected, and the totaling unit 103 transfers the received provision information as it is, to the management server 300. In addition, the provision information will be explained using to the provision information shown in FIG. 5.

When a provision of an article is detected by the provision device 100 “A1” installed in the sales area A, the detection unit 101 generates provision information including the provision device ID “A1” of the provision device 100 and the number of provision “1” (Step S100). The transmission unit 102 transmits it to the management server 300 through the totaling unit 103A (S101).

When the data updating unit 321 receives the provision information from the totaling unit 103A through the transmission unit 330, it searches the article stock data for the provision device ID “A1”, which is included in the provision information, and performs updating by subtracting the number of sales “1” from the stock quantity “10”, which is associated with the provision device ID “A1” so that the stock quantity is “9” (Step S102). The management server 300 executes the above-mentioned operation to all the provision devices, thereby updating the stock information of the provision device information

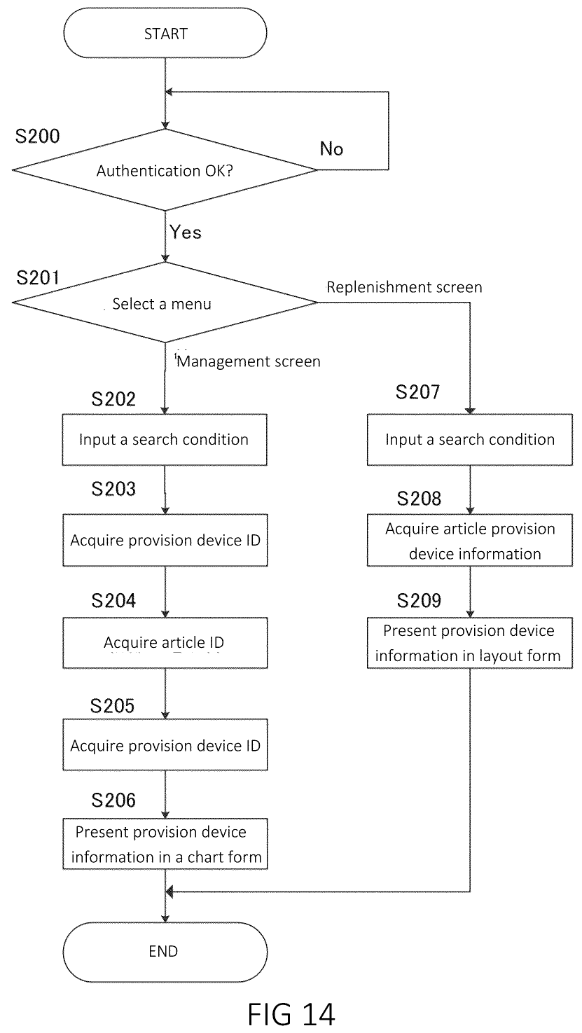

Next, the first presentation processing will be explained, referring to a flowchart shown in FIG. 14. In the example explained below, the provision device information is presented to the administrator terminal 200 of the administrator X. In addition, it is explained referring to the article information and the provision device information shown in FIG. 5 and the administrator information shown in FIG. 6. In the example explained below, the provision device ID of the article provision device information, a store name, a name of the sales area, the address of the sales area, stock information is presented as a management screen to the administer terminal 200 of the administrator X, and a display image and stock information of the article provision device information is presented as a replenishment screen thereto.

The administrator X gains access to the management server 300 by using the administrator terminal 200, and performs authentication by inputting the administrator ID “A” and a password on a login screen (S200).

The administrator X makes a selection for either the management screen or the replenishment screen on the menu screen displayed after the authentication (S201). Here, the management screen is selected. The administrator X inputs a search condition on the search screen (S202). Here, “Café set” is inputted.

The first information acquisition unit 322 searches the administrator information for the ID of the administrator inputted at the login for the administrator terminal 200 wherein the provision device information associated with the provision device ID is set as the range of search target (S203). Here, the provision device information of the provision device IDs “A1”-“A4” which is associated with the administrator ID “A” is for a target object.

The first information acquisition unit 322 acquires the article information of a record(s) which includes the search condition (S204). In the article information shown in FIG. 5, the first information acquisition unit 322 acquires a record of an article name, “Café Set 1”.

The first information acquisition unit 322 acquires a record(s) including both the provision device ID acquired at S203 and the article ID of the record acquired at S204 from the provision device information (S205). In the example of the provision device information shown in FIG. 5, the first information acquisition unit 322 acquires provision device information of a record(s) in which the provision device IDs are “A1” and “A4”, and the article ID “CF1” acquired at S204 is included, among records of the provision device information including the provision devices ID from “A1” to “A4” which are in a range of the retrieval object.

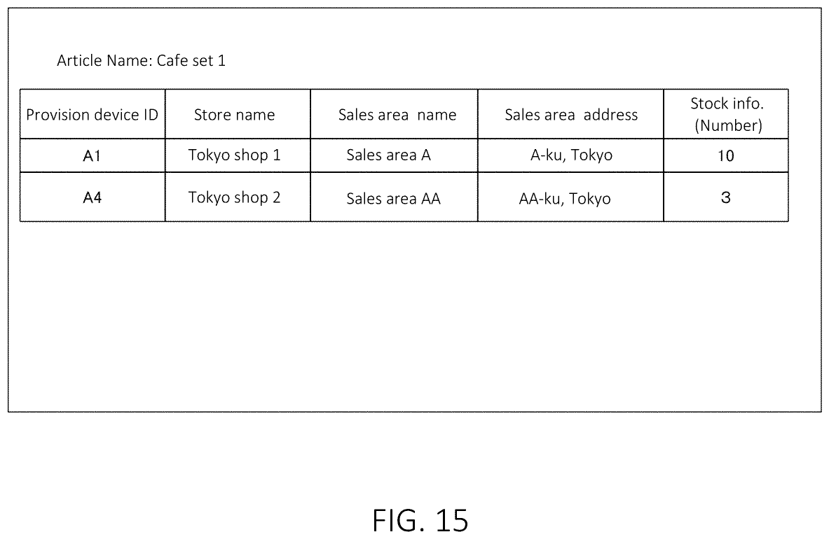

The administration side information presentation unit 324 presents the article provision device information acquired by the first information acquisition unit 323 in form of a chart (S206). FIG. 15 shows an example of presentation in form of a table. FIG. 15 shows an example of a table, which includes, as one record, the provision device ID, a store name, a name of the sales area, an address of the sales area and stock information, wherein the table is presented so as to be associated with the article name “a café set 1”.

At S201, the replenishment screen is selected. The administrator X inputs sales area information on the search screen (S207). In this example, “Sales Area A” is inputted. The first information acquisition 322 acquires article provision device information regarding the inputted sales area (S208). In this example, the first information acquisition unit 322 acquires a display image for “Sales area A” and stock information therefor.

The administration side information presentation unit 324 presents the article provision device information acquired by the first information acquisition unit 323 in form of a layout (S209). FIG. 9 shows an example of the presentation in form of a layout. As shown in FIG. 9, the administration side information presentation unit 324 superimposes the stock information on the display image corresponding to the arrangement/layout of each article provision devices installed in the sales area, and presents it so as to be associated with the sales area information “Sales Area A”.

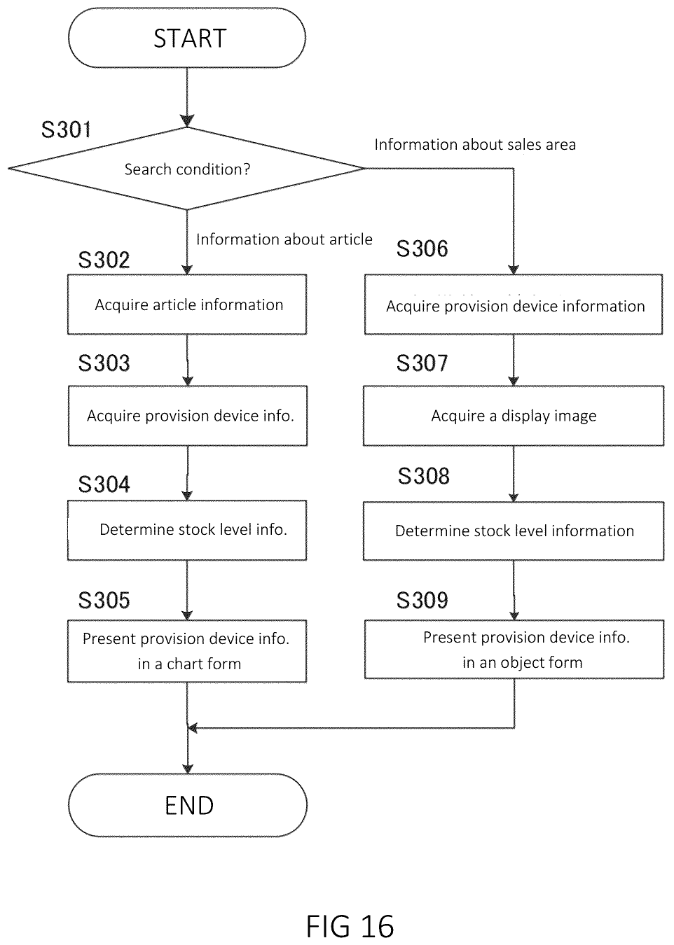

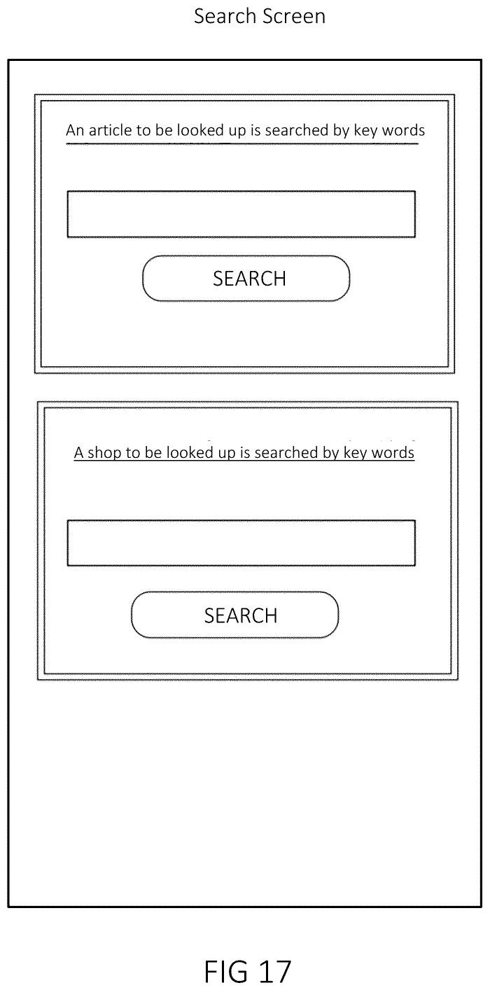

Next, the second presentation processing will be explained referring to a flowchart shown in FIG. 16. The user gains access to the management server 300 by using the user terminal 400, and inputs a search condition on the search screen (S301). FIG. 17 shows the search screen presented to the user terminal 400 at this time. In the example shown in FIG. 7, the user can perform a search from either the information relating to articles or the information relating to sales areas. In this example, “pouch” is inputted in order to perform a search from the information relating to an article.

The second information acquisition unit 323 acquires article information of a record including the inputted search condition (S302). In the example of the article information shown in FIG. 5, the second information acquisition unit 323 acquires the article information of a record including “pouch 1” as an item for the article name.

The second information acquisition unit 323 acquires provision device information of a record of an article ID which is the same as an article ID included in the record of the acquired article information (S303). In the example of FIG. 5, the second information acquisition unit 323 acquires provision device information of a record(s) of an article ID “PC1”, which includes an article name “pouch”, provision device information including a store name “Tokyo shop 2”, a sales area address “A-ku, Tokyo” and stock information “11”, and provision device information which includes a store name “Tokyo shop 3”, a sales area address “B-ku, Tokyo”, and stock information “4”.

The user side information presentation unit 325 determines stock level information, based on the stock information acquired by the second information acquisition unit 323 (S304). In the example shown in FIG. 5, the user side information presentation unit 325 determines that the stock level information is “a circle”, based on the stock information “11” in the provision device information of a record which includes a provision device ID “A2”. The user side information presentation unit 325 determines that the stock level information is “a triangle”, based on the stock quantity “4” in the provision device information of a record which includes a provision device ID “B1”.

The user side information presentation unit 325 presents the article provision device information that the second information acquisition unit 323 reads out, in form of a chart, to the user terminal 400 (S305). FIG. 10 shows one example of presentation in form of a chart (a table). As shown in FIG. 10, the user side information presentation unit 325 presents a table, which includes, as one record, the store name “Tokyo shop 2”, the address “A-ku, Tokyo” and the stock level information “a circle” and which includes, as one record, the store name “Tokyo shop 3”, the Address “B-ku, Tokyo” and the stock level information “a triangle”, wherein the table is associated with the article name “Café Set 1”.

On the other hand, when information relating to the sales area is inputted, the second information acquisition unit 323 acquires the provision device information of a record, which includes the search information inputted by the user (S306). In the example of FIG. 5, “Tokyo shop 1” is inputted, and the second information acquisition unit 323 acquires provision device information of a record, which includes “Tokyo shop 1, provisional device information of a record including a sales area address “A-ku, Tokyo”, an article ID “CF1”, and stock quantity “10”, a record including an article ID “PC1 and stock quantity “11”, and a record including an article ID “KR1” and stock quantity “0”

The second information acquisition 323 acquires a display image of a record of an article ID which is the same as an article ID of the provision device information of the acquired record (S307). In the example shown in FIG. 5, the second information acquisition unit 323 acquires “Image 1”, “Image 2”, “Image 3” for respective records of the article IDs “CF1”, “PC1”, and “KR1”.

The user side presentation unit 325 determines the stock level information to be presented, according to the stock quantity acquired by the second information acquisition unit 323 in S306 (S308). In this example, the user side presentation unit 325 determines that a symbol “a circle”, which indicates there is a stock, is presented for the stock quantity “10”, a symbol “a circle”, which indicates there is a stock, is presented for the stock quantity “11”, and a symbol “X”, which indicates that there is no stock, are presented for the stock quantity “0”.

The user side information presentation unit 325 generates an object image from the display image acquired by the second information acquisition unit 323 at S307 and the stock level information determined by the user side presentation unit 325, and associates the object image with the store name and the sales area address acquired by the second information acquisition unit 323, thereby presenting the article provision apparatus information to the user terminal 400 in form of an object (S309). FIG. 11 shows an example of presentation of the article provision device information in the object format. As shown in FIG. 11, the user side information unit 325 arranges an object image generated from the stock level information and the display image, below the store name “Tokyo shop 1” and the address “A-ku, Tokyo” thereby performing the presentation.

According to the above-described embodiment, the stock information is numerically presented to the administrator terminal 200 and the stock information is presented to the user terminal 400 in form of the stock level, whereby it is possible to present highly useful information to the user in accordance with the user's standpoint. In addition, in the configuration, since authentication is not performed in the user terminal 400, it is easy for the user to light-heartedly search information relating to provision devices and information relating to articles. On the other hand, since the authentication is required in the administrator terminal 200, there is no danger of leakage of information which the administrator does not want the user to know, such as the stock quantity etc.

In addition, since a display image, which is actually attached to or displayed on a provision device 100, is shown on the user terminal 400, the user can perform a search while the user imagines the display image when he or she visits the sales area, so that it becomes easy to search for a provision device(s) 100 from which a desired article is provided.

In addition, in the above-described embodiment, although the configuration in which the totaling unit 103 is provided is explained, the transmission unit 102 may transmits the provision information without any totaling unit 103. However, it is preferred that the provision information is transmitted to the management server 300 through the totaling unit 103. In general, in order that an installation place of the provision device 100 may not be limited, the configuration in which an operation thereof is possible while saving a power such as a battery etc. without a power source, is desired. However, in the case of the configuration in which a power is saved, since a distance capable of transmission by the transmission unit 102 is limited, the provision information may not be directly transmitted to the management server 300. Therefore, it is preferred that the provision information is transmitted through the totaling unit 103.

In addition, although the two or more pieces of the article information and the provision device information are provided to the administrator terminal 200 in the above example, only the stock information of the article provision device information may be presented in form of a table. FIG. 8 shows an example of a screen presented in such a configuration.

In addition, in the above-described embodiment, the administrator cannot display provision device information of the provision device 100 which is administrated by another administrator. In case of an administrator who organizes venders such as a manufacturer, the browsing authority to all the provision devices 100 may be give thereto. In such case, the browsing authority information is provided in the administration information, and the browsing authority may be set depending on each administrator or authority given to administrators. Specifically, at time of login for the administrator terminal 200, the first information acquisition unit 322 checks the provision unit 100 which is a search target set in advance, depending on the browsing authority associated with the inputted administrator ID, and acquires the provision device information of the provision device 100 which is the search target.

### Second Embodiment

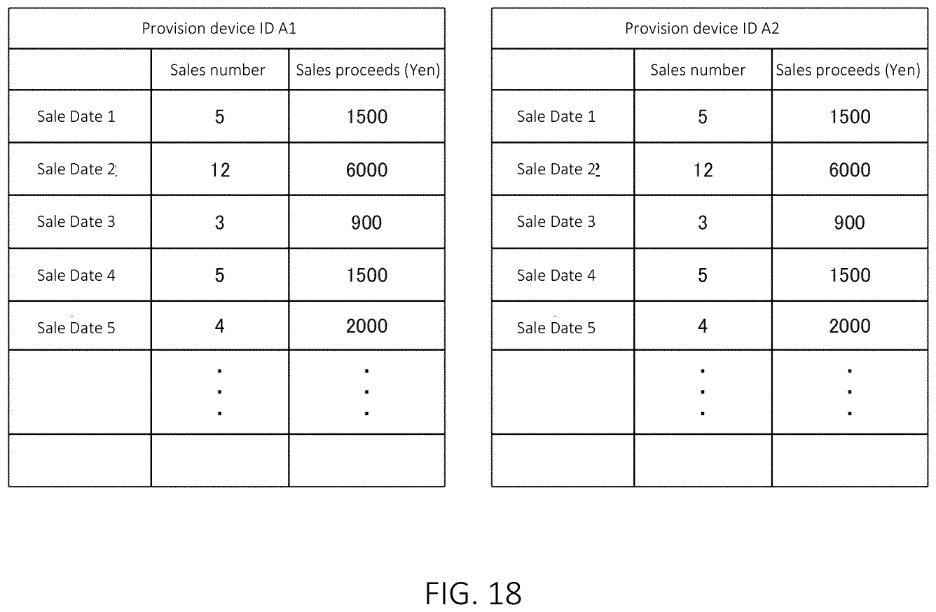

In the present embodiment, sales information is presented on a management screen. The same reference numerals are assigned to the structures similar to those of the above-described embodiment and explanation thereof is omitted. In the second embodiment, a sales information database is provided in order to present the sales information. The sales information database is stored in the memory unit 340. FIG. 18 shows an example of the sales information database according to the present embodiment. In the sales information of each of the provision devices ID in the sales information database, a sale date, the sales number on the sale date and sale proceeds on the sale date are associated with one another.

The data updating unit 321 receives provision information including a provision device ID, the number of provision (sales number) and transmission date and time, from the totaling unit 103. The data updating unit 321 acquires sales information of the provision device included in the provision information, from the sales information database. The data updating unit 321 adds sales number included in the provision information, to the sales number on the sale date, corresponding to the transmission date and time included in the provision information, among pieces of the acquired sales information. When the data updating unit 321 updates the sales number, it calculates sales amount in accordance with the updated sales number, and updates the sales amount on that sale date.

The administrator whose administrator level is a first level, make a selection for a display of a sales screen on the management screen. The administrator inputs a search condition on the sales screen. The search condition includes at least a selling period. In addition to a selling period, it may include any of article information and provision device information. In addition, at least one of the sales number and sales amount may be selectable for display. The first information acquisition unit 322 acquires at least one of the sales number and the sales amount of the provision device 100 which coincides with the search condition, from the sales information. The administration side information presentation unit 324 displays, in a chart form, at least one of the sales number and the sales amount in the selling period, which are acquired by the first information acquisition unit 322.

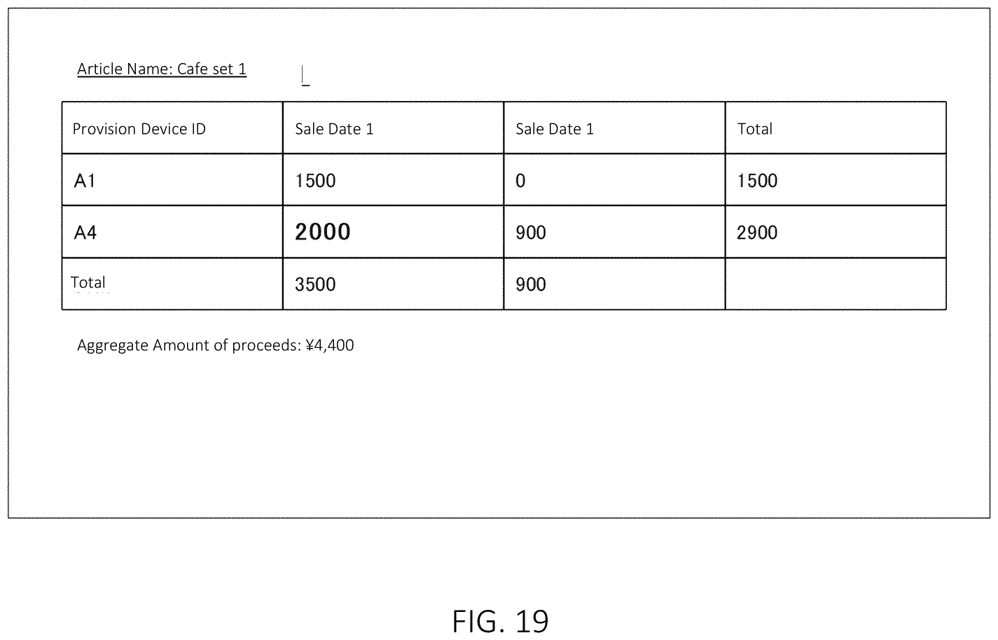

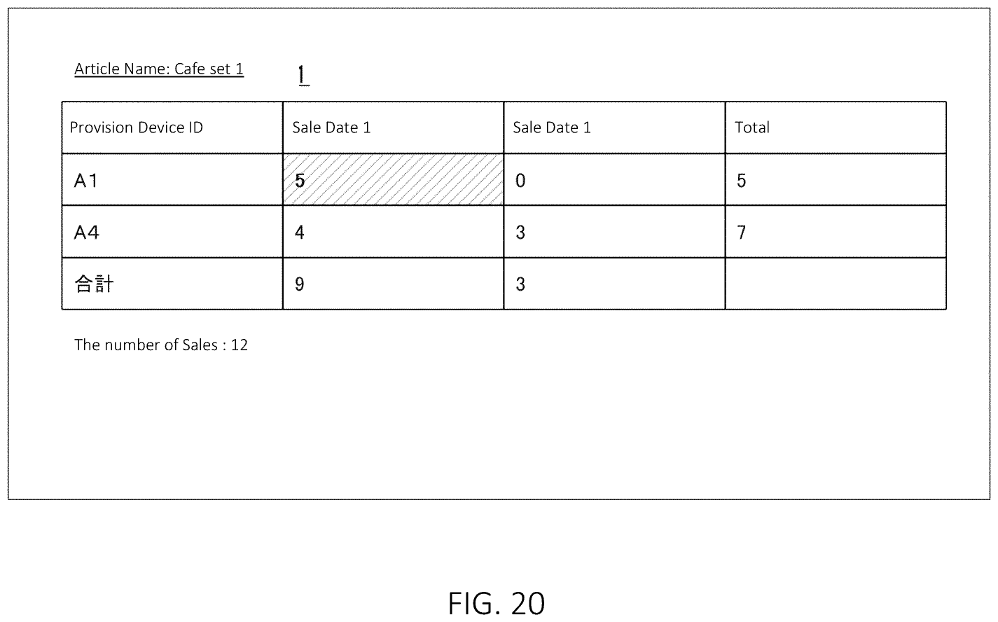

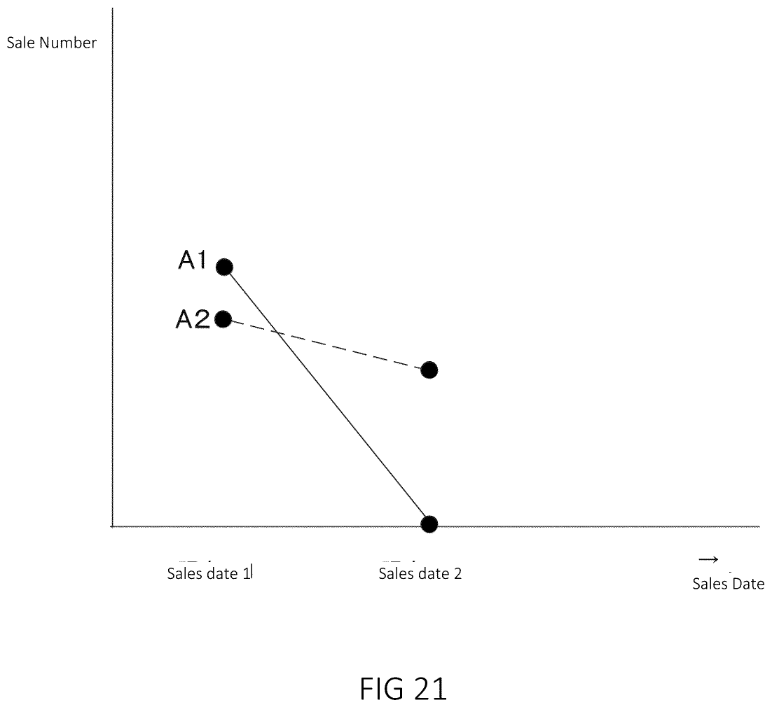

As an example of the chart form, a table including sales number of each provision device, sales amount thereof in a predetermined unit period (for example, daily, monthly or yearly) in chronological order is presented. In this case, it is preferred that it may be presented in a heat map form so that differences from sales number or sales amount of other provision devices may be emphasized (so as to be in different form), depending on the sales number or the sales amount. The emphasized display may be any of color change, bold text, colored field and the like in display form, or may be any other form. Two or more forms may be combined for the emphasized display. FIG. 19 shows an example of presentation of the sales amount in the heat map form. In the example shown in FIG. 19, when the sales amount exceeds ¥2000, it is emphasized in the bold form. FIG. 20 shows an example of presentation of the sales number in the heat map form. In the example shown in FIG. 20, when the sales number exceeds 5, hatching is added to a field thereof for the emphasis display. In addition to these, daily, monthly, and yearly sales number and sales amount may be presented by using a bar chart or a line chart in chronological order. FIG. 21 shows an example of presentation of the sales number shown by a line chart.

According to the present embodiment, since the sales number and sales amount are presented by using such a chart, the administrator can easily figure out a change in the sales at a first sight. In the example explained above, the presentation is performed for the provision devices by which the same article is supplied. However, presentation may be performed for provision devices that provision devices 100 installed in the same sales area provide, that is, for each article.

### Third Embodiment

In the above-described embodiment, an administrator level, which limits the scope of browsing, is not set, for each administrator. However, such an administrator level may be set for each administrator, thereby limiting the scope of browsing. Therefore, in a configuration according to the present embodiment, such an administrator level is set for each administrator, and the information or contents to be presented, and a way of presenting the information is changed in accordance with the assigned administrator level.

In addition to the above embodiments, in the administrator information stored in the memory unit 310, information of the administrator level is associated with an administrator ID and stored therein.

An administrator level is assigned to the administrator, depending on the duty in charge. According to the present embodiment, there are a first level and a second level as the administrator level but it is not limited to them. The administrator having a first level is, for example, an administrator who organizes venders such as a manufacturer. The first level administrator can view both the management screen and the replenishment screen. A second level administrator is, for example, a vender. The second level administrator can view only the replenishment screen.

Similarly to the above embodiment, the administrator gains access to the management server 3 by using the administrator terminal 200, and performs authentication by inputting his or her administrator ID and password in the login screen. The administration side information presentation unit 323 checks the administrator level, which is associated with the administrator ID inputted at the login. When the administrator level is a first level, the administration side information presentation unit 324 displays a menu screen in which a transition to either the management screen or the replenishment screen can be selected. On the other hand, if the administrator level is a second level, the administration side information presentation unit 324 displays the replenishment screen.

The administrator inputs a search condition on the management screen as described in the first embodiment, and article provision apparatus information of the provision device 100 which coincides with the search condition is presented in a chart form.

The administrator inputs a search condition on the replenishment screen as described in the first embodiment, and article provision apparatus information of the provision device 100 which coincides with the search condition is presented thereto in a layout form.

In the sales area, an operation of “replenishment”, “article replacement”, installation and/or “removal” is performed by the administrator. The replenishment is an operation in which the provision device 100 is replenished with articles. The article replacement is an operation for replacing articles provided by the provision device 100. The installation is an operation for installing a new provision device 100 in the sales area. The removal is an operation for removing, from the sales area, a provision device 100 installed in the sales area. The administrator selects and inputs a button for the “replenishment”, “article replacement”, installation or “removal” depending on the respective operations, and updates the provision device information and the administer information. The data updating unit 321 updates the provision device information and the administrator information based on the information inputted by the administrator on the replenishment screen.

According to the present embodiment, two or more administrator levels set for the respective administrators. It is configured that the details of the information to be presented and/or an information presentation form may be different from one another, depending on the assigned administrator level. Thus, since, on the administrator terminals 200 which is used for the entire sales area by the administrator, the article provision device information and article information is presented in a form of a layout which is the same as the layout of the provision devices 100, the administrator in the sales area (a replenishing person) can identify a provision device without doubt, and grasp a status thereof, so that it is possible to enhance the efficiency of the operation for replenishment etc.

### Fourth Embodiment

In an explanation of an example according to this embodiment, when the user side information presentation unit 325 presents low stock (a few left on stock) as the stock level information, it will be presented so as to emphasize differences from the other stock level information so that a user may intuitively recognize that the stock will run out shortly. In addition, the same reference numerals are respectively assigned to similar structures to those of the above-described embodiment, and explanation therefor will be omitted.

When the stock number is such a number that the user side information presentation unit 325 presents that the stock quantity of the article provision device information acquired by the second information acquisition unit 323 is “low in stock”, emphasized display is performed. As the emphasized display, “low stock” is displayed in a color different from that for other stock level information such as red etc. or by bold text, or a symbol(s) or an image which indicates a warning statement may be shown near the stock level information. The user can easily grasp a period during which he or she can receive such an article by displaying it in such an emphasized manner.

Similarly to the user side information presentation unit 325, the administration side information presentation unit 324 may be configured so that the stock information may be displayed while being emphasized when the stock information reaches a predetermined number. By performing a presentation in such emphasized display, the administrator can instantly recognize timing of stock replenishment so that it is possible to provide an article without losing sales opportunities.

In addition, in the administrator terminal 200, the administrator side information display unit 324 may be configured to present, to the administrator terminal 200, the information that the stock of the provision device 100 is zero, when the number of articles in a provision device 100 becomes zero as a result of the update of the stock information by the data updating unit 321. The information that the stock of the provision device 100 is zero may be displayed with emphasis as described above. If the information that the stock is zero is presented in such a manner, the administrator can replenish the stock immediately.

### Firth Embodiment

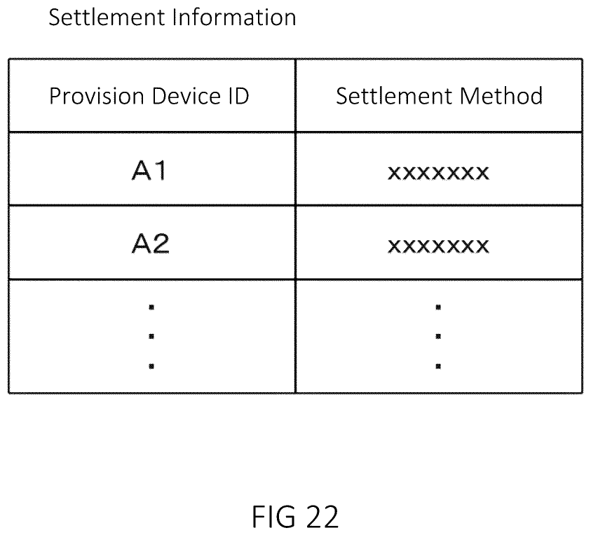

In the above embodiments, although the article information and sales area information is presented to the user terminal 400, information relating to a settlement method which is available in the article presentation device 100 may be presented thereto. FIG. 22 shows an example of the settlement method. The settlement method(s) available in each of the article provision is associated with the provision device ID and is stored.

In recent years, since a payment with electronic money is on the rise, the administrator can provide an article without losing its sales opportunities and a user can acquire the article without losing purchasing opportunities, by showing the information that payment with electronic money is available. In addition, in the above explanation of the example, the settlement information is separately provided but it may be added to the provision device information shown in FIG. 5.

### Sixth Embodiment

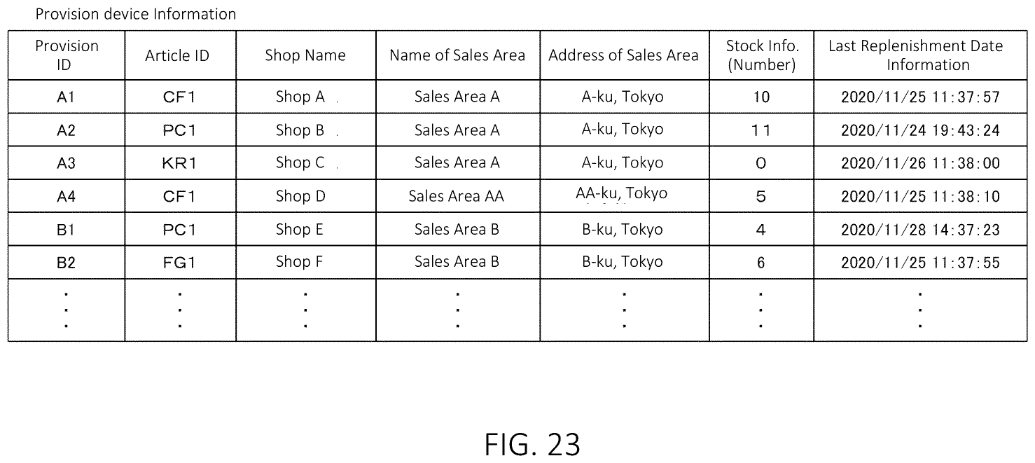

In a configuration according to the present embodiment, information of the last replenishment date and time when articles are replenished to a provision device 100 is included in the provision device information and is presented to the administrator terminal 200. In addition, the same reference numerals are respectively assigned to similar structures to those of the above-described embodiment, and explanation therefor will be omitted. Regarding the provision device information according to the present embodiment, as shown in FIG. 23, the latest replenishment time and date information is added to the provision device information which is explained in the above embodiment.

After the administrator replenishes articles to the article provision device 100, he or she designates the provision device 100, which is replenished with the articles, and inputs the number of the replenished articles, on the replenishment screen which is explained in the second embodiment. The administrator terminal 200 generates replenishment information and transmits it to the management server 300. The replenishment information includes at least provision device ID thereof, the replenishment number, and transmission date and time. The provision device ID is information indicating the provision device 100 which is replenished with the articles. The replenishment number is information indicating the number of replenished articles. The transmission date and time is date and time when the administrator terminal 200 transmits the replenishment information to the management server 300.

When the data updating unit 322 receives the replenishment information from the administrator terminal 200, it searches the provision device information for a record including a provision device ID which is the same as the provision device ID included in the replenishment information. The data updating unit 322 increases the stock information of the record including the matched provision device ID by the replenishment number of the received replenishment information. Further, the date updating unit 322 updates the last replenishment date and time information based on the transmission date and time information of the received replenishment information. Although, in the explanation of this example, the latest replenishment date and time information is updated based on the date and time when the replenishment information is transmitted, it may be the date and time when the administrator inputs it.

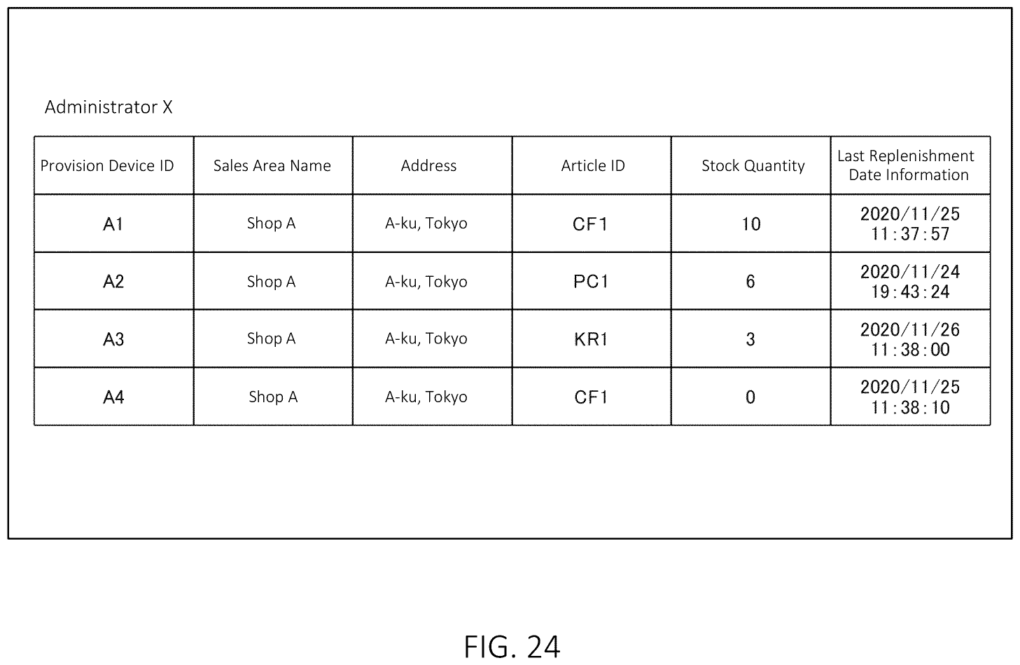

The first information acquisition unit 323 acquires the provision device information which includes the latest replenishment date and time information. The administration side information presentation unit 324 adds the latest replenishment date and time information, which is acquired by the first information acquisition unit, to the provision device information, which is presented in a chart format, and performs a presentation thereof. FIG. 24 shows an example of the provision device information in a chart format, which is presented by the administration side information presentation unit 324 according to the present embodiment.

According to the present embodiment, the administrator checks the latest replenishment date and time and stock quantity, so that he or she can grasp the selling situation such as a speed of sales etc.

In the above description, the present invention is explained based on preferred embodiments. However, all the elements in the embodiment are not indispensable and they may be combined with each other as needed. The present invention is not limited to the above-described embodiments, and may be modified in various ways within a scope of the technical idea.

All or parts of the above-described embodiments may be described as in additional remarks set forth below, but are not limited thereto.

[Additional Remark 1]

An article management method comprises a step of acquiring article provision device information which relates to an article provision device satisfying a search condition of an administrator who administers an article provision device from which articles is provided and includes stock information of the articles to be provided from the article provision device; a step of presenting, to an administrator terminal, the article provision device information, in which the stock information in the article provision device information is shown as detailed information, a step of acquiring article provision device information which relates to an article provision device satisfying a search condition of a user and includes stock information of articles to be supplied from the articles provision device, and a step of presenting, to a user terminal, the article provision device information in which the stock information in the article provision device is shown as simple information different from the detailed information.

[Additional Remark 2]

In the article management method according to the Additional Remark 1, the accuracy of the detailed information is higher than that of the simple information.

[Additional Remark 3]

In the article management method according to the Additional Remark 1 or 2, the article provision device information, which can be presented to the administrator terminal, is the article provision device information of the article provision device for which a browsing authority is required, and the article provision device information, which can be presented to the user terminal, is article provision device information of the article provision device for which no browsing authority is required.

[Additional Remark 4]

In the article management method according to any of the Additional Remarks 1-3, the detailed information or the simple information is presented for each sales area where article provision devices are installed.

[Additional Remark 5]

In the article management method according to any of the Additional Remarks 1-4, the stock information in the article provision device information, which can be presented to the administrator terminal as the detailed information, is stock quantity, and the stock information in the article provision device information, which can be presented to the user terminal as the simple information, is a stock level.

[Additional Remark 6]

In the article management method according to any of the Additional Remarks 1-5, a control is performed so that either a first presentation format for presenting the article provision device information in a chart format or a second presentation format for presenting the article provision device information in a layout format in which the article provision device information is arranged so as to correspond to a layout of article provision devices in a sales area, can be selected.

[Additional Remark 7]

In the article management method according to the Additional Remarks 6, the first presentation format or the second presentation format can be selected, depending on the browsing authority assigned to the administrator.

[Additional Remark 8]

In the article management method according to the Additional Remarks 7, when the stock quantity indicates zero or the stock level indicates a low stock or no stock, it is presented in a form different from the other stock information of articles provided by the other provision devices.

[Additional Remark 9]

In the article management method according to any of the Additional Remarks 1-8, the article provision device information includes at least one of sales area information indicating the sales area where the article provision devices are installed, and article information relating to articles provided by the article provision device.

[Additional Remark 10]

In the article management method according to the Additional Remark 9, the article information includes at least any of an article name, an article price information an article explanation information.

[Additional Remark 11]

In the article management method according to the Additional Remark 10, the explanation information includes a display image which is attached to or is displayed on article provision devices installed in the sales area.

[Additional Remark 12]

In the article management method according to any of the Additional Remarks 1-11, sales volume and sales proceeds of the article provision device are totaled up by using the number of times that an article provision device provides an article in a predetermined unit period, and sales information in which the sales volume and the sales proceeds of the article provision device in the predetermined unit period are arranged in chronological order is presented in a predetermined display form according to the sales volume and the sales proceeds.

[Additional Remark 13]

In the sales information of the article management method according to the Additional Remark 12, in the sales information, the sales volumes and the sales amounts of the respective article provision devices installed in the same sales area in the predetermined unit period, or the sales volumes and the sales amounts of the respective article provision devices which provide the same articles in the predetermined unit period, are arranged so as to be compared with one another.

[Additional Remark 14]

In the article management method according to any of the Additional Remarks 1-13, a database in which stock information in the article provision device information is recorded is updated, by using the number of times of provision of articles in the article provision device.

[Additional Remark 15]

In the article management method according to any of the Additional Remarks 1-14, the stock information of the article provision device database is updated based on the sales information of each article provision device which is collected from each of the article provision devices.

[Additional Remark 16]

In the article management method according to the Additional Remark 15, the article provision device database is updated on condition that the article provision device is replenished with articles.

[Additional Remark 17]

In the article management method according to the Additional Remark 16, the article provision device database is updated on condition that replenishment of the article provision device with articles is detected.

[Additional Remark 18]

In the article management method according to the Additional Remark 17, the detection of articles is made by a detection of an operation execution of an operation unit for article provision, which is set in the provision device.

[Additional Remark 19]

In the article management method according to the Additional Remark 17, the detection of an article is made by a detection of article provision made by a sensor provided in the article provision device.

[Additional Remark 20]

In the article management method according to any of the Additional Remarks 1-19, the simple information is associated with the sales area information relating to the sales area where the article provision device is installed, and is presented.

[Additional Remark 21]

In the article management method according to any of the Additional Remarks 5-20, the stock level information is presented by either two or more different images or a symbol(s).

[Additional Remark 22]

In the article management method according to any of the Additional Remarks 1-21, either the simple information or the detailed information is presented for each of the sales area.

[Additional Remark 23]

In the article management method according to any of the Additional Remarks 1-22, the stock level information is associated with the information of the sales area where article provision devices are installed and is presented.

[Additional Remark 24]

In the article management method according to any of the Additional Remarks 1-23, settlement information corresponding to the article provision device is acquired from an article provision device database where the settlement information indicating whether or not an electronic money settlement is available for each of the article provision device is recorded, and is presented to the user terminal.

[Additional Remark 25]

A server comprises a first acquisition unit for acquiring article provision device information which relates to an article provision device satisfying a search condition inputted by an administrator who administers the article provision device from which an article(s) is provided and which includes stock information of articles to be provided from the article provision device, a first presentation unit for presenting, to an administrator terminal, the article provision device information, in which the stock information in the acquired article provision device information is shown as detailed information, a second acquisition unit for acquiring article provision device information which relates to an article provision device satisfying a search condition inputted by a user and which includes stock information of articles to be supplied from the article provision device, and a second presentation unit for presenting, to a user terminal, the article provision device information in which the stock information of the acquired article provision device is shown as simple information different from the detailed information.

[Additional Remark 23]

A program causes a computer to function as a first acquisition unit for acquiring article provision device information which relates to an article provision device satisfying a search condition inputted by an administrator who administers the article provision device from which an article(s) is provided and which includes stock information of articles to be provided from the article provision device, a first presentation unit for presenting, to an administrator terminal, the article provision device information, in which the stock information in the acquired article provision device information is shown as detailed information, a second acquisition unit for acquiring article provision device information which relates to an article provision device satisfying a search condition inputted by a user and which includes stock information of articles to be supplied from the article provision device, and a second presentation unit for presenting, to a user terminal, the article provision device information in which the stock information of the acquired article provision device is shown as the simple information different from the detailed information.

### REFERENCE NUMERALS

100 Provision device
200 Administrator terminal
300 Management server
321 Data updating unit
322 First information acquisition unit
323 Second information acquisition unit
324 Administration side information presentation unit
325 User side information presentation unit
400 User terminal

1. An article management method comprises the following steps of:
acquiring article provision device information which relates to an article provision device satisfying a search condition by an administrator who manages an article provision device from which an article is provided, and which includes stock information of the article to be provided from the article provision device;
presenting, to an administrator terminal, the article provision device information, in which the stock information in the article provision device information is shown as detailed information,
acquiring the article provision device information which relates to the article provision device satisfying a search condition by a user and which includes the stock information of the article to be supplied from the article provision device, and
presenting, to the user terminal, the article provision device information in which the stock information of the article provision device is shown as the simple information different from the detailed information.

2. The article management method according to claim 1, wherein accuracy of the detailed information is higher than that of the simple information.

3. The article management method according to claim 1, wherein the article provision device information, which can be presented to the administrator terminal, is article provision device information of the article provision device for which a browsing authority is required, and the article provision device information, which can be presented to the user terminal, is article provision device information of the article provision device for which no browsing authority is required.

4. The article management method according to claim 1, wherein the detailed information or the simple information is presented for each sales area where article provision devices are installed.

5. The article management method according to claim 1, wherein the stock information of the article provision device information, which can be presented to the administrator terminal as the detailed information, is stock quantity, and the stock information of the article provision device information which can be presented to the user terminal as the simple information, is a stock level.

6. The article management method according to claim 1, wherein a control is performed so that either a first presentation format for presenting the article provision device information in a chart format or a second presentation format for presenting a layout format in which the article provision device information is arranged corresponding to a layout of article provision devices in a sales area, can be selected.

7. The article management method according to claim 1, wherein the first presentation format or the second presentation format can be selected, depending on the browsing authority assigned to the administrator.

8. The article management method according to claim 7, wherein the stock quantity indicates zero or the stock level indicates a low stock or no stock, the stock information is presented in a form different from stock information of the article provided by the other provision devices.

9. The article management method according to claim 1, wherein the article provision device information includes at least one of sales area information indicating the sales area where the article provision devices are installed and article information relating to the article provided by the article provision device.

10. The article management method according to claim 9, wherein the article information includes at least one of an article name, article price information and article explanation information.

11. The article management method according to claim 10, wherein the explanation information includes a display image which is attached to or is displayed on the article provision device installed in the sales area.

12. The article management method according to claim 1, wherein sales volume and sales proceeds of the article provision device in a predetermined unit period are totaled up by using the number of times that an article provision device provides the article, and sales information, in which the sales volume and the sales proceeds of the article provision device in the predetermined unit period are arranged in chronological order, are presented in a predetermined display form according to the sales volume and the sales proceeds.

13. The article management method according to claim 12, wherein, in the sales information, the sales volumes and the sales amounts of the respective article provision devices installed in the same sales area in the predetermined unit period, or the sales volumes and the sales amounts of the respective article provision devices which provide the same article in the predetermined unit period, are arranged so as to be compared with each other.

14. The article management method according to claim 1, wherein a database in which stock information of the article provision device information is recorded is updated, by using the number of times of provision of the article in the article provision device.

15. A server comprising:
a first acquisition unit for acquiring article provision device information which relates to an article provision device satisfying a search condition by an administrator who manages an article provision device from which an article is provided, and which includes stock information of the article to be provided from the article provision device;
a first presentation unit for presenting, to an administrator terminal, the article provision device information, in which the stock information in the acquired article provision device information is shown as detailed information;
a second acquisition unit for acquiring the article provision device information which relates to the article provision device satisfying a search condition by a user, and which includes the stock information of the article to be supplied from the article provision device; and
a second presentation unit for presenting, to the user terminal, the article provision device information in which the acquired stock information of the article provision device is shown as simple information different from the detailed information.

16. A program, which causes a computer to function as:
a first acquisition unit for acquiring article provision device information which relates to an article provision device satisfying a search condition by an administrator who manages the article provision device from which an article is provided, and which includes stock information of the article to be provided from the article provision device;
a first presentation unit for presenting, to an administrator terminal, the article provision device information, in which the acquired stock information in the article provision device information is shown as detailed information;
a second acquisition unit for acquiring the article provision device information which relates to the article provision device satisfying a search condition by a user, and which includes the stock information of the article to be supplied from the article provision device; and
a second presentation unit for presenting, to the user terminal, the article provision device information in which the acquired stock information of the article provision device is shown as simple information different from the detailed information.
